(19) United States
(12) Patent Application Publication
(10) Pub. No.: US 2017/0291832 A1
(43) Pub. Date: Oct. 12, 2017

(54) Electrolytic water softener

(71) Applicant: Ozomax Inc., Shefford (CA)

(72) Inventors: Amir Salama, Shefford (CA); Marianne Salama, Shefford (CA)

(73) Assignee: Ozomax Inc., Shefford (CA)

(21) Appl. No.: 15/731,008

(22) Filed: Apr. 6, 2017

(30) Foreign Application Priority Data
Apr. 11, 2016 (CA) 2926658

(51) Int. Cl. C02F 1/42; H01M 4/02; B06B 1/06; C02F 1/461; B06B 1/02

(52) U.S. Cl. CPC C02F 1/42; C02F 1/46104; B06B 1/02; B06B 1/0618; H01M 4/02; C02F 2201/461; C02F 2001/422; C02F 2001/425; C02F 2001/46133; H01M 2004/027; H01M 2004/028

(57) ABSTRACT

An electrolytic water softener which comprises a container, at least one cathode and at least one anode extending into the container, a power supply operatively connected to the cathode and anode, a vibrating device to vibrate the cathode, and a system for collecting material released from the cathode after operation of the vibration device.

### FIELD OF THE INVENTION

The present invention relates to water softeners and more particularly, relates to a self-cleaning electrolytic water softener. The invention also relates to a method for cleaning water.

### BACKGROUND OF THE INVENTION

It is well known in the art to treat water to remove dissolved chemicals therefrom (the water is known as hard water). There have been many methods both proposed and utilized in various applications.

To carry out the removal of hardness from water the methods used in common practise are the precipitation of hardness through boiling or through the reaction with other chemicals and the capture of hardness ions using ion exchange zeolites or resins. Electrocoagulation using aluminum anodes has also been studied but is not widely used. Finally, using an electrochemical cell to create a zone of high pH near the cathode to precipitate hardness has also been described but is not widely applied.

### 1. Precipitation Through Boiling,

Boiling can be used to eliminate temporary hardness, that is, the hardness caused by the presence of dissolved calcium bicarbonate and magnesium bicarbonate. When dissolved, these minerals yield calcium and magnesium cations (Ca²⁺, Mg²⁺) and carbonate and bicarbonate anions (CO₃²⁻, HCO₃⁻). For example, for the concentration of calcium bicarbonate in water following the equilibrium reaction

CaCO₃₍ₛ₎+H₂O₍ₗ₎+CO_{2(aq)} [symbol] Ca(HCO₃)_{2(aq)}ΔH−ve

Since this reaction is exothermic in the forward direction, Le Chatelier's principle predicts that at high temperatures, the equilibrium will move to the left.

On boiling, calcium/magnesium bicarbonate decomposes to give calcium/magnesium carbonate, which is insoluble in water. The problem with this method is that it that it cannot remove permanent hardness, that is, hardness usually caused by the presence of calcium sulfate and/or magnesium chloride in the water as they do not precipitate out as the temperature increases. Secondly, the amount of energy required by this method makes it economically prohibitive.

### 2. Precipitation Through the Addition of Slaked Lime Known as Clark's Process,

In Clark's process, slaked lime, Ca(OH)₂ is added to remove temporary hardness from water. Insoluble calcium carbonate precipitates out of solution and no longer produces hardness.

Ca(HCO₃)₂(aq)+Ca(OH)₂(aq)→2CaCO₃(s)+2H₂O(l)

Mg(HCO₃)₂(aq)+Ca(OH)₂(aq)→CaCO₃(s)+MgCO₃(s)+2H₂O(l)

There are many problems with this method. First, it cannot be used to remove permanent hardness. Second, slaked lime is itself a source of calcium ions (and hence hardness) so care must be taken to avoid adding an excess. Third, the sludge produced must be collected, dewatered and disposed of making it impractical for small to medium scale installations. Fourth, water is lost in the dewatering process.

### 3. Precipitation Through the Addition of Sodium Carbonate,

Calcium and magnesium ions present in the water in the form of temporary and permanent hardness react with sodium carbonate to produce insoluble carbonates. These precipitates no longer contribute to the water hardness level.

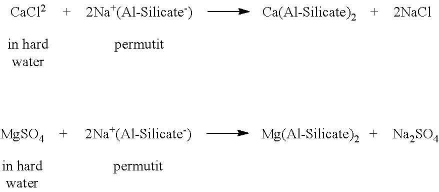

This method is impractical for small to medium scale installations. First, there is a need to constantly replenish the supply of sodium carbonate and second, the resulting sludge must be collected, dewatered and disposed of. Third, water is lost in the dewatering process.

4. Using an ion-exchange process that passes the hard water through beds of insoluble ion-exchange media that capture hardness causing ions and exchanges them for non-hardness causing ions that are subsequently released into the treated water.

One such method is the Permitut process which uses naturally occuring sodium aluminum silicate known as zeolite to soften water by capturing calcium and manganese ions and releasing sodium into the softened water in exchange. The outgoing water contains sodium salts, which do not cause hardness.

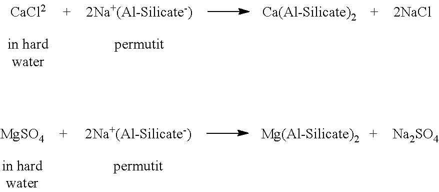

Over a period of time permutit is converted into a mixture of calcium and magnesium aluminium-silicates and has to be regenerated for further use. This is done by flowing brine—a concentrated solution of sodium chloride, through the column packed with spent permutit. The following reactions take place.

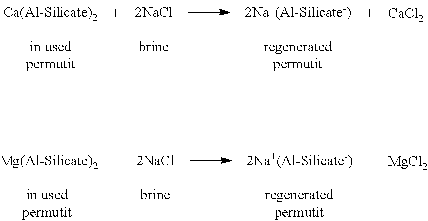

The resulting calcium chloride and magnesium chloride produced, are washed out through a tap at the bottom. The regenerated permutit is reused for softening water. The drawbacks of this method are that the regeneration process requires that a brine solution be available at all times for regeneration and also requires some water to be wasted as calcium and magnesium chloride are sent to the drain. This method also increases the sodium content of the drinking water which can be harmful to people with certain medical conditions such as hypertension or cardiovascular diseases.

Another type of ion exchange process uses organic based ion-exchange resins which can be either acidic resins or basic resins. Acidic resins capture cations such as Ca²⁺, Mg²⁺ and release H+ ions into the water. Basic resins exchange their OH³¹ ions with the other anions such as HCO₃⁻, Cl⁻, SO₄²⁻, present in hard water. After some time, the resins require regeneration as they become ineffective. Adding a strong acid regenerates acid resin and the basic resin is regenerated by treating it with a solution of a strong base. The drawbacks of this method are that the regeneration process requires that concentrated acid and basic solutions be available at the installation location. If they are available, safety precautions must be put in place to ensure the safety of the user. The regeneration process also requires that some water be wasted and sent to the drain.

### 5. Electrocoagulation Using Soluble Anodes of Aluminum or Iron

Electrocoagulation is a water treatment process whereby an electric current is applied across metal plates to electrochemically form a desired coagulating agent (e.g., Al3+ or Fe3+) without adding sulfate or chloride anions to the treated water. For example, if aluminum anodes are used, the following reactions take place

Anode: Al₍ₛ₎---->Al³⁺_{(aq)}+3e⁻

Cathode: 3H₂O+3e⁻----->3/2 H_{2(g)}+3 OH⁻

Since hydroxide is formed at the cathode, the precipitation of temporary hardness, occurs according to the reaction:

Ca²⁺+HCO₃⁻+OH−---->CaCO₃₍ₛ₎+H₂O

The coagulating agent formed insitu, in this case Al³⁺, draws the hardness precipitates together to form large particles which settle at the bottom of the reactor.

The disadvantages of this method are that the anodes are eventually consumed and must be replaced, that a large amount of sludge is produced which must be collected, dewatered and disposed of, that some water is wasted during the dewatering process and in the case of aluminum anodes, the excess aluminum ions in the resulting drinking water have undesirable health effects such as increasing the risk of Alzheimers disease.

### 6. Electrolytic Precipitation of Hardness

Electrolytic scale removal is based on the generation of a high pH environment around the cathode by the following cathodic reactions:

2H2O+2e−→H2↑+2OH−1

O2+2H2O+4e−→4OH−1

The high alkaline environment hardness is precipitated

Ca²⁺+HCO₃⁻+OH−---->CaCO₃₍ₛ₎+H₂O

The high pH conditions also promote precipitation of magnesium hydroxide:

Mg+2+2OH−1 Mg(OH)2↓

The efficiency of this process decreases with time as scale forms on the cathode increasing the overall resistance of the electrochemical cell. The common practice used to remove this scale is to periodically reverse polarity. This causes the cathode to dissolve and requires that it be replaced from time to time. Also this method is most efficient at high pH levels which may not be suitable for drinking.

Known electrolytic cells include an arrangement wherein there is provided at least one anode and at least one cathode. The use of such cells results in build-up of unwanted films on the surface of the electrode or electrodes and in particular, there is a build-up of contaminants on the cathode. The build-up consists of the various contaminants in the feed water and typically consists of material such as magnesium, calcium carbonate, etc. The build-up of these films is not controlled when they are not removed on a fairly regular basis, the electrolytic cells will lose a high degree of operating efficiency and will eventually fail due to electric arcing or the like.

### SUMMARY OF THE INVENTION

It is therefore an object of the present invention to provide an electrolytic water softener and a method wherein there is provided an arrangement wherein the cathode is vibrated and the material released thereby is collected from underneath the cathode.

According to one aspect of the present invention, there is provided an electrolytic water softener comprising a container, at least one cathode extending into the container, at least one anode extending into the container, a power supply operatively connected to the at least one cathode and the at least one anode, means to vibrate the cathode, and a system for collecting material released from the cathode after operation of the means to vibrate the cathode.

According to a further aspect of the present invention, there is also provided a method for softening water comprising the steps of passing water through a container, the container having at least one cathode and at least one anode extending into the container, supplying power to the at least one cathode and the at least one anode, periodically vibrating the cathode, and collecting material released from the cathode.

The present invention may be practiced either as a continuous water softening operation or on a batch basis. When practiced on a batch basis, any size container which is practical can be utilized. The scaling up or scaling down of the operation may be achieved by utilizing a desired number of cathodes and anodes as required. The amount of time will be a function of the volume of the container, the power supplied to the cathodes and anodes and the degree of hardness of the water.

The invention includes vibrating the cathode at a desired interval time so that material coating the cathode will be removed and fall to the bottom of the container.

The means of vibrating the cathode to remove the composites thereon can vary. Thus, a mechanical arrangement wherein the cathode or cathodes are vibrated can include a mechanical vibration. Thus, a vibratory device such as an electric, mechanical or pneumatic hammer or the like may be utilized. In one embodiment, a vibration is imparted to all the cathodes simultaneously. In order to do so, the cathodes may be connected together by means of a frame member which is vibrated and passes the vibration on to the cathodes which are connected thereto.

An alternative method to vibrate the cathodes utilizes cathodes which are made with piezoelectric properties. Thus, one could utilize any organic ceramic plate or organic polymer with piezoelectric properties. The cathode may be covered with a metallic surface. The polarity can be reversed from time to time if desired. Other materials for the anode include lead oxides, mixed metal oxides, and various platinum materials, boron doped diamond deposited by CVD or other methods.

The cathode could also be made of metal memory material such as Nitinol. Nitinol alloys exhibit two closely related and unique properties; shape memory effect and super elasticity which is also called sudo elasticity. Shape memory is the ability of Nitinol to undergo deformation at one temperature and then recover its original undeformed shape upon heating above its transformation temperature. Thus, one could have an embedded resistance heating circuit to provide slight heating and which could make the material change its shape and thereby discard any hardness deposits on its surface.

A further alternative would be to make the cathode in the shape of an angular pouch of an electrically conductive polymer such as polyaniline and/or other conducting polymers such as polythiophene, polypyrrole and pedot\PSS. These materials have potential for applications due to their light weight, conductivity, mechanical flexibility and low cost. Still further, a conductive silicon composite upon inflation and deflation using compressed air would discard any deposit material.

A still further method of vibrating may utilize a sound wave emitting device such as an ultrasonic transducer which would be positioned to impart a vibration to the cathode. In addition to the action of the ultrasonic waves and/or vibrations, the power supply polarity may be reversed from time to time to further aid in the shedding of the deposits from the cathode.

The precipitates from the cathode can be allowed to fall to the bottom of the container where they may automatically be purged by means of a solenoid valve which opens periodically and flushes the bottom wafer portion or by pumping the water to a filtration step to remove the precipitated hardness or a combination of both.

The electrochemical device of the present invention may also be designed to produce mixed oxidants such as oxygen, oxygen radicals, ozone, hydroxyl radicals at the anode which will remove microbiological contamination, organics such as taninns and inorganic contaminants such as iron and manganese and other heavy metals by oxidation.

### BRIEF DESCRIPTION OF THE DRAWINGS

Having thus generally described the invention, reference will be made to the accompanying drawings illustrating an embodiment thereof, in which:

FIG. 1 is a schematic view illustrating the arrangement of cathodes and anodes which may be utilized with a container to treat water; and

FIG. 2 is a schematic view illustrating an arrangement wherein precipitates are collected at the bottom of a container.

### DETAILED DESCRIPTION OF THE INVENTION

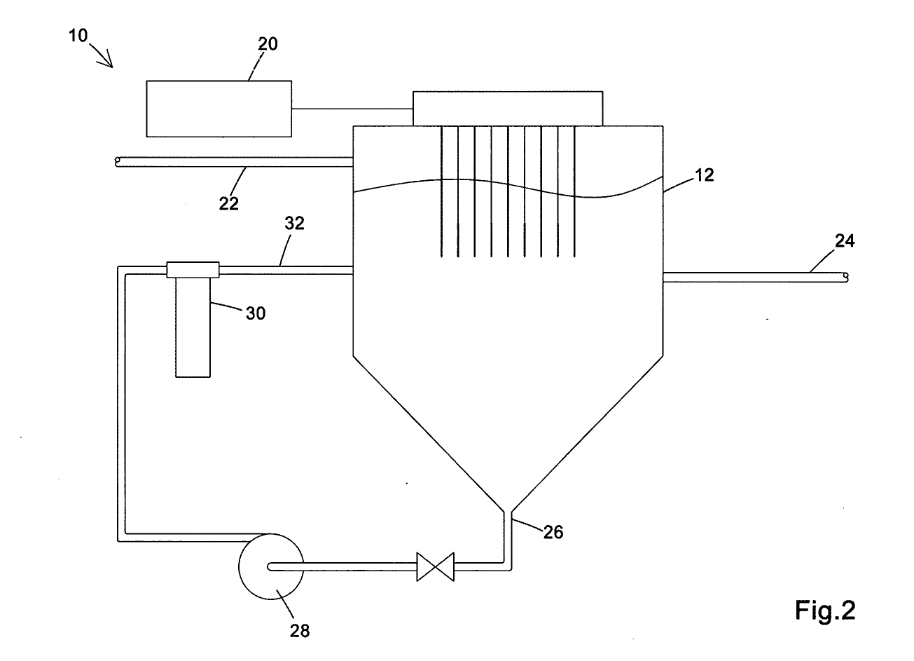

As shown in FIG. 2, there is provided an electrolytic water softener which is generally designated by reference numeral 10.

Electrolytic water softener 10 includes a container 12 into which there are inserted a plurality of anodes 14 and a plurality of cathodes 16. An electrode holder or frame member 18 is secured to cathodes 16. A vibrator 20 is connected to one end of electrode holder 18 to impart vibrations thereto.

Electrolytic water softener 10 includes an inlet conduit 22 to container 12 and an outlet conduit 24. At the bottom of container 12, there is provided a precipitate discharge drain 26. A pump 28 is designed to pump fluid (including the precipitate) through a filter 30 with the filtered liquid re-entering container 12 by means of a return line 32.

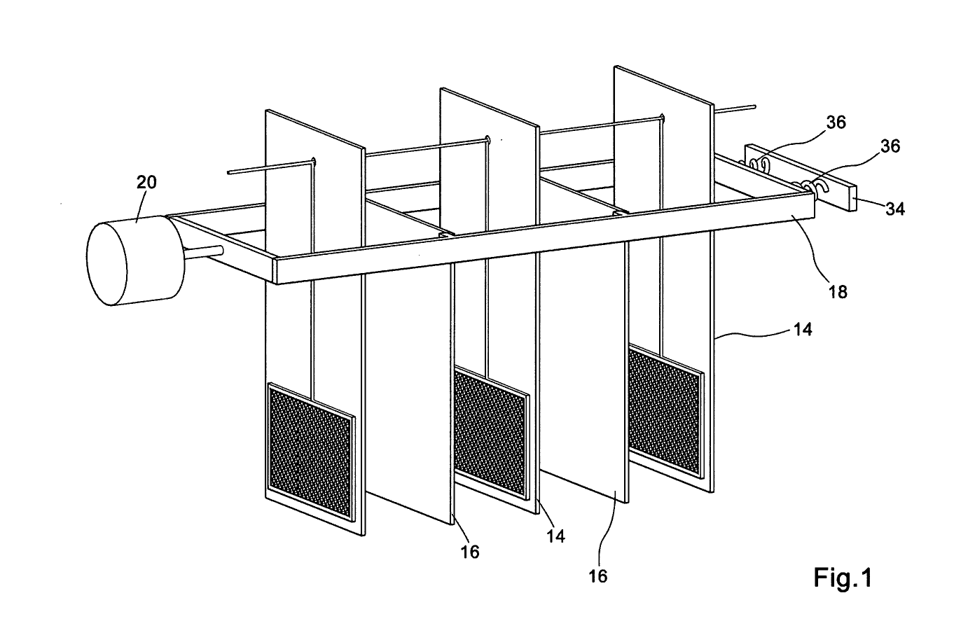

As shown in FIG. 1, vibrator 20 is connected to each cathode 16 and in the illustrated embodiment, comprises a mechanical vibrator designed to impart pulses to electrode holder 18 and thus to cathodes 16. A base plate 34 is provided and springs 36 are mounted between base plate 34 and electrode holder 18.

### EXAMPLE 1

The device of this invention used in this example for the removal of hardness from well water was a prototype consisting of a conical cylinder type reactor as shown in FIG. 2. The removal of hardness from the water was performed by an electrochemical cell that caused the hardness to deposit on its cathode. This hardness layer was then released from the cathode through the use of a mechanical vibrator which actuated every 30 minutes for a period of five seconds. The shaking of the cathode by the mechanical vibrator caused the hardness deposits to fall from the cathode and accumulate in the conical portion of the reactor. Water from this section of the reactor was periodically pumped through a two step filtration process consisting of two cartridge-type sediment filters. The first filtration stage was performed at a porosity of five microns and was followed by a second filtration stage of one micron porosity. The filtered water was then recycled back to the reactor. The vessel of the reactor had diameter of twenty inches, an overall height of thirty inches and a capacity of thirty US gallons.

The electrochemical cell consisted of fourteen metallic electrodes. Seven electrodes were comprised of a flat platinum plated niobium mesh measuring about six inches by about six inches each. The other seven electrodes were aluminum plates measuring about ten inches wide by about twenty inches long each. The seven platinum electrodes were connected together to define the anode and, similarly, the seven aluminum plates were connected together to define the cathode. These flat electrodes were alternatively positioned so as to face each other and connected to an opposite pole of the power supply such as to define seven consecutive electrolytic cells.

The direct current power supply was delivering a current of 19.5 amps and 19.5 volts. The water to be treated had an initial Total Hardness Concentration of 414 ppm which, according to Guidelines for Canadian Drinking Water Quality, is considered to be very hard water. This test water originated from a residential artesian well and was used “as is”, that is without the addition of any other chemicals. The Total Dissolved Solids (TDS) concentration of the test water was 410 ppm, which is equivalent to a conductivity of 820 uSiemens/cm.

About 30 gallons of this well water was placed in the reactor and treated for 150 minutes under the conditions described above. The treated water had a Total Hardness Concentration of 174 ppm, representing a reduction of 58%. After 500 minutes of treatment a reduction of 75% in Total Hardness was achieved yielding a final concentration of 84 ppm.

The experiment was repeated using 40 amps and a voltage of 40 volts, that is, double the values used in the initial experiment. The volume of water treated in the reactor was the same, namely, 30 US gallons. The doubling of the current density allowed the Total Hardness to be reduced 75% in a treatment time of 120 minutes, dropping from an initial concentration of 420 ppm to a final concentration of 108 ppm in about ¼ of the time used in the initial experiment. The production of mixed oxidants was also measured under these conditions using the DPD colorimetric method. The total concentration of mixed oxidants (the combined total of ozone, hydrogen peroxide, and dissolved oxygen) was found to be 1.6 ppm after 38 minutes of operation and 3.8 ppm after 92 minutes of operation.

### EXAMPLE 2

The device used in this example for the removal of hardness from well water was a prototype consisting of a conical cylinder type reactor as shown in FIG. 2. This prototype differs from the one described in Example 1 in the configuration of the electrochemical cell, in the use of ultrasound waves to release the hardness deposits from the cathodes and in the use of a single stage filtration step. The reactor had diameter of twenty inches, an overall height of thirty (30) inches and a capacity of thirty US gallons.

The electrochemical cell consisted of six platinum rod electrodes each measuring twenty-four inches long. Five electrodes were placed two centimetres apart in a circular fashion around a central electrode. The five outer electrodes were connected together to define the cathode whereas the central rod served as the anode. The anode and cathode were also two centimetres apart. Piezoelectric ultrasound transducers were connected to the cathode and actuated every second minute for a period of one minute. The ultrasound waves cleaned the cathode of hardness which then accumulated at the bottom of the conical reactor. This water was filtered using a five micron cartridge filter and returned to the reactor.

The direct current power supply was delivering a current of 8 amps and 40 volts. The water to be treated had an initial Total Hardness Concentration of 420 ppm which, according to Guidelines for Canadian Drinking Water Quality, is considered to be very hard water This test water originated from a residential artesian well to which 1 g/L of sodium bicarbonate was added in order to increase the water's conductivity and achieve a current of 8 amps. After this addition the Total Dissolved Solids (TDS) concentration of the test water was 800 ppm, which is equivalent to a conductivity of 1600 uSiemens/cm.

About 30 gallons of this well water was placed in the reactor and treated for 280 minutes under the conditions described above. The treated water had a Total Hardness Concentration of 249 ppm, representing a reduction of 41%. After 720 minutes of treatment a reduction of 64% in Total Hardness was achieved yielding a final concentration of 150 ppm.

The production of mixed oxidants was also observed. Using the DPD colorimetric method the total concentration of mixed oxidants (the combined total of ozone, hydrogen peroxide, dissolved oxygen) was found to exceed 2.2 ppm after 280 minutes of operation.

It will be understood that the above described embodiment is for purposes of illustration only and that changes and modifications may be made thereto without departing from the spirit and scope of the invention.

We claim:

1. An electrolytic water softener comprising:
a container;
at least one cathode extending into said container;
at least one anode extending into said container;
a power supply operatively connected to said at least one cathode and said at least one anode;
means to vibrate said cathode; and
a system for collecting material released from said cathode after operation of said means to vibrate said cathode.

2. The electrolytic water softener of claim 1 including a plurality of cathodes extending into said container.

3. The electrolytic water softener of claim 2 including a plurality of anodes extending into said container, said plurality of cathodes and said plurality of anodes being arranged sequentially.

4. The electrolytic water softener of claim 1 wherein said means to vibrate said cathode comprise mechanical means.

5. The electrolytic water softener of claim 1 wherein said means to vibrate said cathode comprise pneumatic means.

6. The electrolytic water softener of claim 1 wherein said cathodes are formed of a piezoelectric material.

7. The electrolytic water softener of claim 1 wherein said means to vibrate said cathode comprise an ultrasonic transducer.

8. The electrolytic water softener of claim 1 wherein said cathode is formed of a plastic material having a metallic exterior.

9. The electrolytic water softener of claim 1 wherein said anode is formed of a material selected from the group consisting of platinum mesh, lead oxides, mixed metal oxides, platinum materials, boron doped diamond.

10. The electrolytic water softener of claim 1 wherein said cathode is formed of a metal memory material.

11. The electrolytic water softener of claim 10 wherein said metal memory material is Nitinol or an alloy thereof.

12. The electrolytic water softener of claim 1 wherein said cathode is formed of an electrically conductive polymer in the shape of an angular pouch.

13. A method for softening water comprising the steps of:
passing water through a container, the container having at least one cathode and at least one anode extending into said container;
supplying power to said at least one cathode and said at least one anode, periodically vibrating said cathode; and
collecting material released from said cathode.

14. The method of claim 13 wherein said step of vibrating said cathode comprises mechanically vibrating said cathode.

15. The method of claim 13 wherein said step of vibrating said cathode comprises the step of operating a transducer proximate said cathode.
